(19) United States
(12) Patent Application Publication
(10) Pub. No.: US 2025/0347983 A1
(43) Pub. Date: Nov. 13, 2025

(54) IMAGE PICKUP APPARATUS AND IMAGE PICKUP APPARATUS SYSTEM THAT ENABLE USE OF HANDLE AND ACCESSORY TOGETHER AND ARE CAPABLE OF ENSURING GOOD ATTACHMENT OF THE ACCESSORY

(71) Applicant: CANON KABUSHIKI KAISHA, Tokyo (JP)

(72) Inventors: MASATO YOKOSAWA, Tokyo (JP); YUKO IRITANI, Tokyo (JP); YOJI OYA, Kanagawa (JP)

(21) Appl. No.: 19/197,321

(22) Filed: May 2, 2025

(30) Foreign Application Priority Data
May 9, 2024 (JP) 2024-076531

(51) Int. Cl. G03B 17/56; G03B 17/55

(52) U.S. Cl. CPC G03B 17/566; G03B 17/55; G03B 17/563; G03B 2217/002

(57) ABSTRACT

An image pickup apparatus that enables use of a handle and an accessory together and is capable of ensuring good attachment of the accessory is provided. The image pickup apparatus includes a first fixing portion to which at least a handle is capable of being fixed, a second fixing portion to which an accessory is capable of being fixed, and a display unit that includes a display surface perpendicular to an optical axis direction. The first fixing portion is located on a subject side in the optical axis direction with respect to the second fixing portion and is located above the second fixing portion. The second fixing portion is located on the subject side in the optical axis direction with respect to the display unit, and is located above an uppermost position of the display unit.

### BACKGROUND OF THE INVENTION

### Field of the Invention

The present invention relates to an image pickup apparatus and an image pickup apparatus system.

### Description of the Related Art

Conventionally, the portability, the operability, or the functionality of an image pickup apparatus has been improved by attaching a handle for making the image pickup apparatus easier to carry or a function extension accessory such as a microphone to the image pickup apparatus. In order to achieve this, some image pickup apparatuses are provided with a fixing portion, which includes a fixing hole, an accessory shoe, and the like for attaching the handle and the function extension accessory, on the main body of the image pickup apparatus.

For example, in a technique disclosed in Japanese Laid-Open Patent Publication (kokai) No. 2021-190835, a holder member is capable of being fixed to one end of a handle portion at any phase, and the holder member is capable of being fixed to the main body of a camera. A function extension accessory is capable of being placed at the other end of the handle portion at a desired angle. However, the technique disclosed in Japanese Laid-Open Patent Publication (kokai) No. 2021-190835 does not provide a configuration in which the handle and the function extension accessory are capable of being used simultaneously. Therefore, there is a possibility of narrowing the flexibility of the operability and the functionality of the image pickup apparatus (the camera) in a photographing scene. In addition, in recent years, the number of large function extension accessories has been increasing to allow for further extendability. Therefore, even in the case of considering a configuration in which a handle and a function extension accessory are capable of being used together, it is necessary to consider the ease of attaching the function extension accessory.

### SUMMARY OF THE INVENTION

The present invention provides an image pickup apparatus and an image pickup apparatus system that enable use of a handle and an accessory together and are capable of ensuring good attachment of the accessory.

Accordingly, the present invention provides an image pickup apparatus comprising a first fixing portion to which at least a handle is capable of being fixed, a second fixing portion to which an accessory is capable of being fixed, and a display unit that includes a display surface perpendicular to an optical axis direction. The first fixing portion is located on a subject side in the optical axis direction with respect to the second fixing portion and is located above the second fixing portion. The second fixing portion is located on the subject side in the optical axis direction with respect to the display unit, and is located above an uppermost position of the display unit.

Accordingly, the present invention provides an image pickup apparatus system comprising the image pickup apparatus, and a handle that is capable of being fixed to the first fixing portion of the image pickup apparatus. The handle comprises a first portion that includes an area that is primarily held, a second portion that is a portion that is folded back at an end portion in a longitudinal direction of the first portion, the second portion including an area that is fixed to the first fixing portion, and a strut portion that connects the first portion and the second portion. Spaces, into which fingers of a hand holding the first portion is capable of fitting, are formed on both sides of the strut portion.

According to the present invention, it is possible to enable the use of the handle and the accessory together and be capable of ensuring the good attachment of the accessory.

Further features of the present invention will become apparent from the following description of exemplary embodiments with reference to the attached drawings.

### BRIEF DESCRIPTION OF THE DRAWINGS

FIG. 1A is a front perspective view of an image pickup apparatus system.

FIG. 1B is a front perspective view of the image pickup apparatus system.

FIG. 1C is a rear perspective view of the image pickup apparatus system.

FIG. 1D is a rear perspective view of the image pickup apparatus system.

FIG. 2 is an exploded perspective view that shows components of an image pickup apparatus.

FIG. 3 is a top view of the image pickup apparatus.

FIG. 4 is a side view of the image pickup apparatus as viewed from the +X side.

FIG. 5 is a rear perspective view of the image pickup apparatus.

FIG. 6 is a top view of the image pickup apparatus.

FIG. 7 is a rear view of the image pickup apparatus.

FIG. 8A is a partial top view of the image pickup apparatus.

FIG. 8B is a partial top view of the image pickup apparatus.

FIG. 9A is a front perspective view of an image pickup apparatus system.

FIG. 9B is a front perspective view of the image pickup apparatus system.

FIG. 9C is a side view of an image pickup apparatus as viewed from the −X side.

FIG. 10 is a partial rear perspective view of an image pickup apparatus main body.

FIG. 11 is a partial rear perspective view of the image pickup apparatus main body.

FIG. 12 is a partial front perspective view of the image pickup apparatus with a handle attached.

### DESCRIPTION OF THE EMBODIMENTS

The present invention will now be described in detail below with reference to the accompanying drawings showing embodiments thereof.

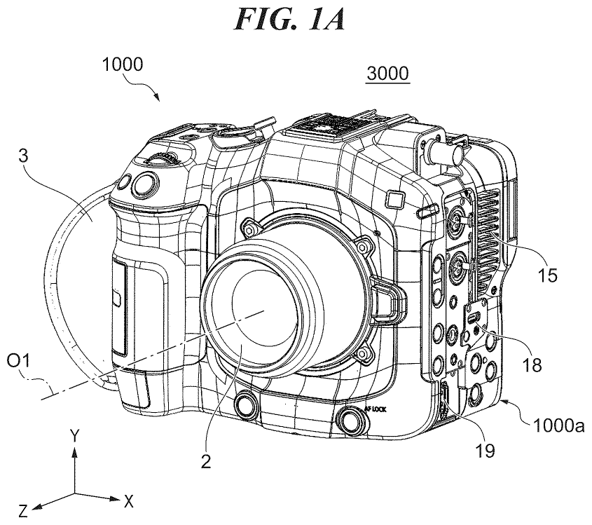

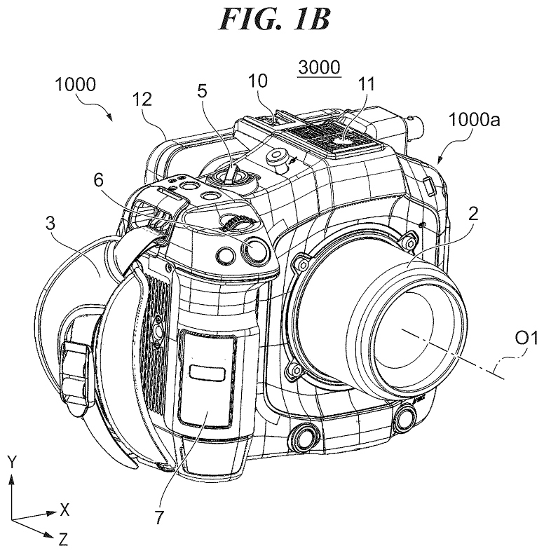

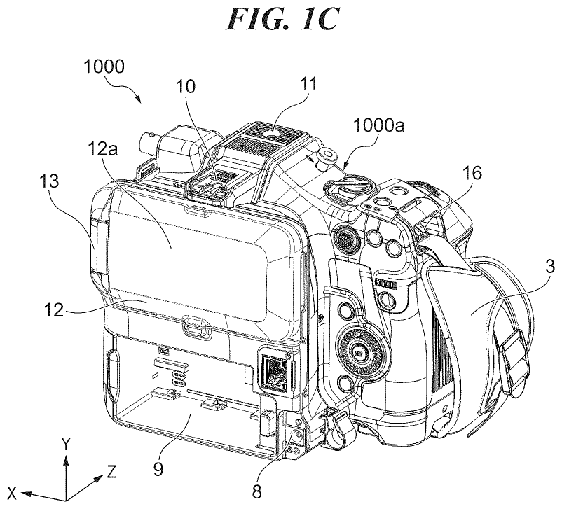

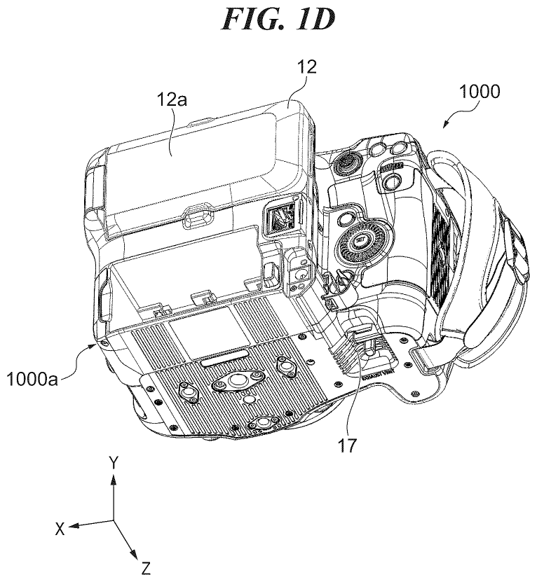

First, a first embodiment of the present invention will be described. FIG. 1A and FIG. 1B are front perspective views of an image pickup apparatus system 3000 including an image pickup apparatus according to the first embodiment. FIG. 1C and FIG. 1D are rear perspective views of the image pickup apparatus system 3000 according to the first embodiment.

The image pickup apparatus system 3000 according to the first embodiment includes an image pickup apparatus 1000, a lens 2, a grip belt 3, and a handle (not shown). The image pickup apparatus 1000 includes an image pickup apparatus main body 1000a and a display unit 12.

Hereinafter, directions of respective parts of the image pickup apparatus system 3000 according to the first embodiment will be defined based on the X, Y, and Z coordinate axes that are shown in FIG. 1A and the like. Here, for convenience, a direction parallel to an optical axis O1 of the lens 2 connected to the image pickup apparatus 1000 is defined as the Z-axis direction, and on a plane perpendicular to the Z-axis direction, a width direction of the image pickup apparatus 1000 is defined as the X-axis direction, and a top-and-bottom direction of the image pickup apparatus 1000 is defined as the Y-axis direction. Concerning positive and negative directions, the +Y direction is upward, and the +Z direction is forward. The +X direction is to the right as viewed from a subject side.

The lens 2 is capable of being attached to/detached from the image pickup apparatus main body 1000a, and FIG. 1A and FIG. 1B show a state in which the attachable/detachable lens 2 has been attached to the photographing subject side (the +Z side). It should be noted that the image pickup apparatus 1000 may be a camera with an integrated lens.

On a side portion of the image pickup apparatus main body 1000a on the +X side, various kinds of operation portions have been arranged in addition to connection terminals for connecting to external devices, such as a USB terminal 18 and an HDMI (registered trademark) terminal 19. In addition, as shown in FIG. 1B, the image pickup apparatus main body 1000a is provided with a power switch 5 for turning the power of the image pickup apparatus 1000 on and off, a recording operation portion 6 for starting and stopping recording, and a recording portion 7 for performing recording onto a card medium.

In addition, as shown in FIG. 1C, the image pickup apparatus main body 1000a is provided with a DC jack 8 for performing power supply and a battery chamber 9 for accommodating a battery (not shown). An accessory shoe 10 (a second fixing portion) and a fixing hole 11 (a first fixing portion) are disposed on an upper portion of the image pickup apparatus main body 1000a. The accessory shoe 10 has an electrical contact, and an external accessory for function extension is capable of being physically and electrically connected to the accessory shoe 10. The fixing hole 11 is a screw hole, and the handle (not shown) or the like is capable of being fixed thereto by a fixing screw or the like.

The image pickup apparatus main body 1000a is provided with the movable display unit 12. The display unit 12 is a so-called vari-angle monitor that is capable of rotating around an opening/closing hinge 13, which has two perpendicular axes, as a central axis. An image is displayed on a display surface 12a of the display unit 12.

As shown in FIG. 1C, the grip belt 3 has been arranged on a side portion of the image pickup apparatus main body 1000a on the −X side. A photographer is able to hold the image pickup apparatus 1000 in one hand by putting his/her hand through the grip belt 3 and supporting the image pickup apparatus 1000. In the first embodiment, the grip belt 3 has been arranged on the left side surface so that the photographer is able to easily hold the image pickup apparatus 1000 with his/her right hand.

Next, a heat dissipation function will be described.

The image pickup apparatus main body 1000a is equipped with a forced air-cooling function using a fan in order to cool heat generating elements on substrates contained therein. The image pickup apparatus main body 1000a is provided with a main body air intake port 15 that opens toward the +X direction as an air intake port (see FIG. 1A). In addition, the image pickup apparatus main body 1000a is provided with a first main body air exhaust port 16 that opens toward the −X direction as an air exhaust port (see FIG. 1C).

Here, the grip belt 3 is attached below the first main body air exhaust port 16. Therefore, in the case where the photographer holds the image pickup apparatus 1000 by using the grip belt 3, the exhaust air from the first main body air exhaust port 16 does not reach the holding hand.

In addition, a second main body air exhaust port 17 that opens toward the −Y direction is provided on a bottom surface, which is a surface on the −Y side of the image pickup apparatus main body 1000a (see FIG. 1D). Here, a concave shape around the second main body air exhaust port 17 in the image pickup apparatus main body 1000a is open on the rear surface side (the −Z side) but is not open on the front surface side (the +Z side). Therefore, the second main body air exhaust port 17 is not capable of being seen from the front surface side, and the aesthetic appearance is maintained. On the other hand, even when the image pickup apparatus 1000 is placed on the floor, the exhaust air is capable of escaping to the rear surface side without being blocked by the floor surface, so the cooling performance of the image pickup apparatus 1000 is ensured.

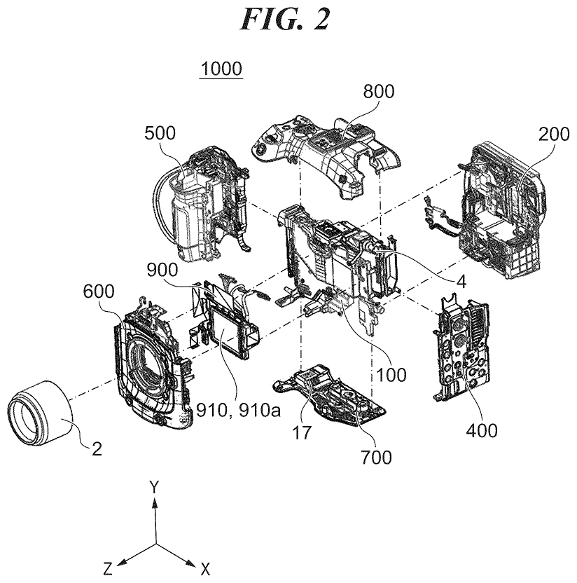

FIG. 2 is an exploded perspective view that shows components of the image pickup apparatus 1000.

As shown in FIG. 2, the image pickup apparatus 1000 broadly includes a main unit 100, a rear unit 200, a grip unit 500 (a holding portion), an R unit 400, a sensor unit 900, an F unit 600, a bottom unit 700, and a top unit 800.

The main unit 100 includes forced cooling parts such as a duct and the fan, a main control substrate, a power supply section, etc. The main control substrate controls the entire image pickup apparatus 1000. The rear unit 200 includes the display unit 12 which is a liquid crystal panel and the battery chamber 9 (see FIG. 1C). The grip unit 500 includes a grip portion that includes the recording portion 7 (see FIG. 1B). The R unit 400 includes the operation portions, the connection terminals, and the main body air intake port 15 (see FIG. 1A). The sensor unit 900 includes a sensor substrate that includes an image pickup device 910 (an image sensor 910). The image pickup device 910 converts the light entering through the lens 2 into electrical signals. A surface on the +Z side of the image pickup device 910 is a light receiving surface 910a. The F unit 600 includes an ND unit that is made of optical glass for adjusting the amount of light, and a mount portion for connecting the lens 2. The bottom unit 700 includes the second main body air exhaust port 17 (see FIG. 1D). The top unit 800 includes the power switch 5 (see FIG. 1B).

The image pickup apparatus 1000 is assembled as follows. First, a worker attaches the main unit 100 to the rear unit 200, and then attaches the grip unit 500. Next, the worker attaches the R unit 400, which has included the operation portions, the USB terminal 18, the HDMI terminal 19, and the main body air intake port 15, and then attaches the F unit 600 with the ND unit attached, and the sensor unit 900 to the main unit 100. Then, the worker attaches the top unit 800 and the bottom unit 700, and then attaches the desired lens 2 to the F unit 600. Next, a relative arrangement relationship (relative positions) of the accessory shoe 10, the fixing hole 11, and the display unit 12 will be described.

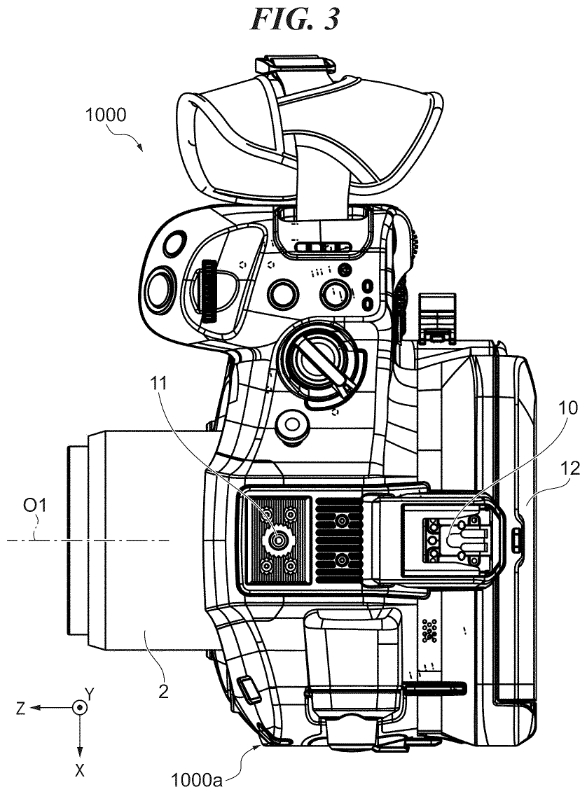

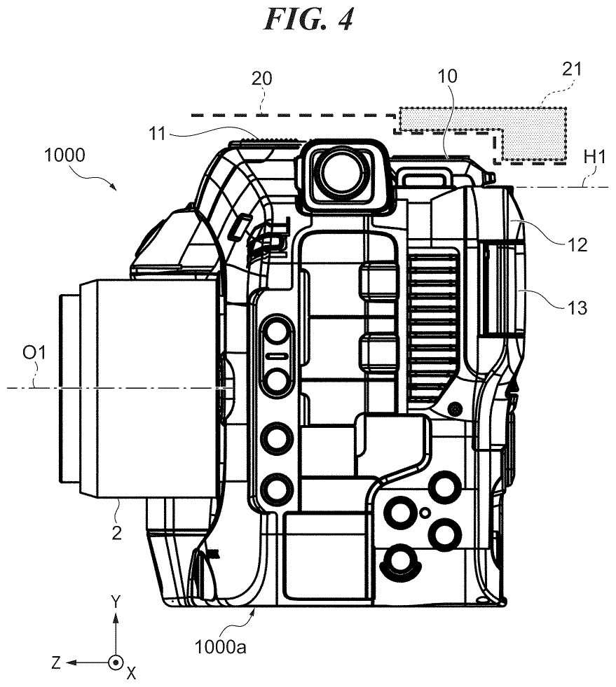

FIG. 3 is a top view of the image pickup apparatus 1000. FIG. 4 is a side view of the image pickup apparatus 1000 as viewed from the +X side. The display unit 12 is capable of being opened and closed relative to the image pickup apparatus main body 1000a, and in FIGS. 1A to 1D, 3, and 4, the display unit 12 is in a closed state. When the display unit 12 is in the closed state, the display surface 12a of the display unit 12 is perpendicular to the optical axis O1 direction.

As shown in FIG. 3, when viewed from the +Y side, the fixing hole 11, the accessory shoe 10, and the display unit 12 have been arranged in series in the optical axis O1 direction. In other words, from the subject side, the fixing hole 11, the accessory shoe 10, and the display unit 12 have been arranged in this order. In addition, as shown in FIG. 4, the outer shape of each of the accessory shoe 10, the fixing hole 11, and the display unit 12 has a step in the Y direction. From the +Y direction, the steps are located in the order of the fixing hole 11, the accessory shoe 10, and the display unit 12. An outer shape line 20 schematically shows a height relationship of the image pickup apparatus 1000 in FIG. 4.

In other words, the fixing hole 11 is located on the subject side in the optical axis O1 direction with respect to the accessory shoe 10, and is located above the accessory shoe 10. The accessory shoe 10 is located on the subject side in the optical axis O1 direction with respect to the display unit 12, and is located above the uppermost position H1 (see FIG. 4) of the display unit 12. It should be noted that when the movable display unit 12 is at any of its movable positions, the display unit 12 does not overlap with the fixing hole 11 and the accessory shoe 10 when viewed from the optical axis O1 direction.

The reason for such an arrangement is as follows. First, an accessory is attached to the accessory shoe 10 from the −Z direction. Therefore, in order not to place any obstacles in the attaching direction, the accessory shoe 10 is disposed on the −Z side than the fixing hole 11. The display unit 12 is disposed at the rearmost part of the image pickup apparatus 1000 so that the photographer is able to easily confirm (check) the photographing screen.

In addition, as shown in FIG. 4, the fixing hole 11 is disposed at the top of the image pickup apparatus 1000 so that the handle (not shown) that makes it easy to hold (grip) the image pickup apparatus 1000 is capable of being freely fixed. As shown by the outer shape line 20, the accessory shoe 10 is located on the −Y side than the fixing hole 11 and is located on the +Y side than the display unit 12, so that a space is created from the +Y side area of the accessory shoe 10 to the −Z side area. This space becomes an accessory attaching space 21. The above relative arrangement makes it possible to secure a large accessory attaching space 21. Even in the case where the handle has been fixed, the accessory is capable of being easily attached and detached.

In this way, by arranging the fixing hole 11, the accessory shoe 10, and the display unit 12 in the optical axis direction and in the height relationship that is shown by the outer shape line 20, the handle and the accessory are capable of being attached simultaneously, improving the workability and the operability during photographing. In addition, even a large-size accessory that requires a large accessory attaching space 21 is capable of being easily attached to and detached from the accessory shoe 10.

Next, the external appearance shape of the area around the operation portions will be described.

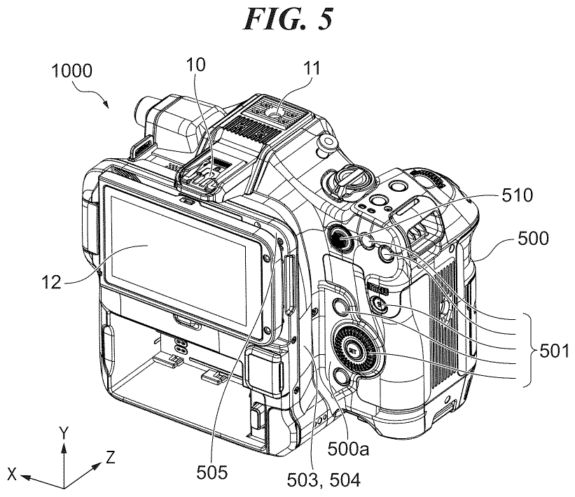

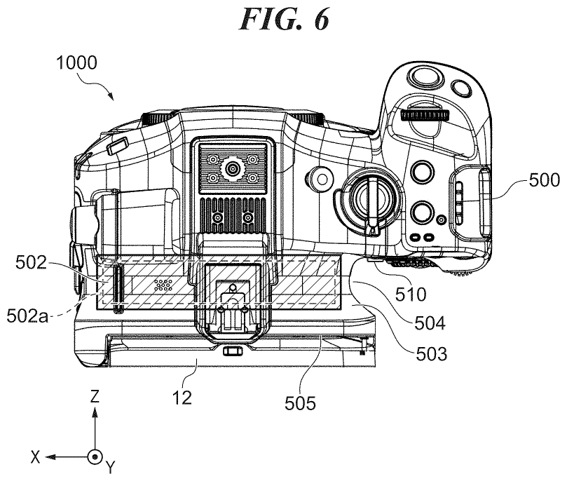

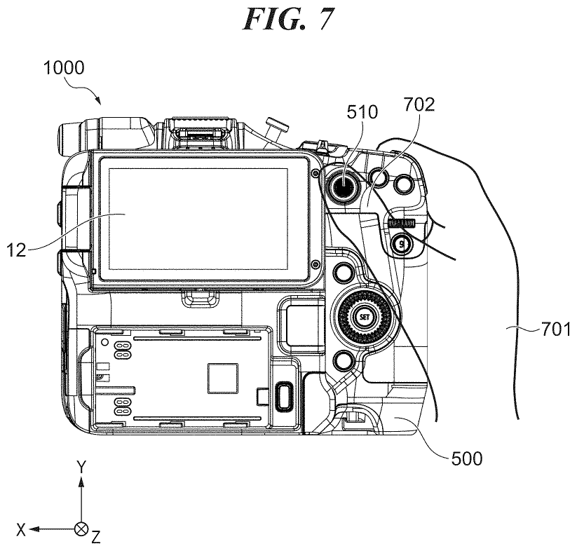

FIG. 5, FIG. 6, and FIG. 7 are a rear perspective view, a top view, and a rear view, respectively, of the image pickup apparatus 1000. The grip unit 500 is disposed on the left side portion of the image pickup apparatus main body 1000a. Therefore, normally, the photographer performs photographing by holding the grip unit 500 with a right hand 701 (his/her right hand) and supporting other parts such as the lens 2 with his/her left hand.

On the rear surface side of the grip unit 500, in addition to the display unit 12, an eight-direction key 510 and various kinds of operation members 501 that are operated when performing settings for photographing conditions and the like are disposed as operation members. In other words, the eight-direction key 510 and the various kinds of operation members 501 are disposed on an arrangement surface 500a of the grip unit 500, which is a surface facing the photographer side in the optical axis O1 direction. The eight-direction key 510 and the various kinds of operation members 501 are disposed at positions that are operable by a thumb 702 of the right hand 701 holding the grip unit 500. Since the operation members are capable of being operated by the thumb 702 of the right hand 701, the photographer is able to operate the operation members while still holding the image pickup apparatus 1000, and there is no hindrance to operation even during photographing.

Here, a protrusion portion 503 is provided on the image pickup apparatus main body 1000a. The protrusion portion 503 is a portion that protrudes toward the photographer side than the arrangement surface 500a in the optical axis O1 direction. In the closed state, the display unit 12 faces a top surface 505, which is a surface on the photographer side of the protrusion portion 503.

As the image pickup apparatus 1000 becomes higher in the resolution and the frame rate, power consumption in the image pickup device 910 and electrical substrates during photographing increases, and the amount of heat generated increases, so that the inside of the image pickup apparatus 1000 is prone to becoming hot. For this reason, a cooling structure 502a including a fan and a duct is equipped so as to prevent the inside of the image pickup apparatus 1000 from becoming excessively hot. As described above, in the structure in which the grip unit 500 is integrally provided on the side portion of the image pickup apparatus 1000, the thickness of the grip unit 500 is not capable of being changed significantly from the standpoint of the ease of holding the image pickup apparatus 1000. Therefore, as shown in FIG. 6, the cooling structure 502a is disposed in a cooling structure installation range 502 when viewed from the Y direction (the top-and-bottom direction). The cooling structure installation range 502 is disposed inside of the protrusion portion 503, thereby saving space.

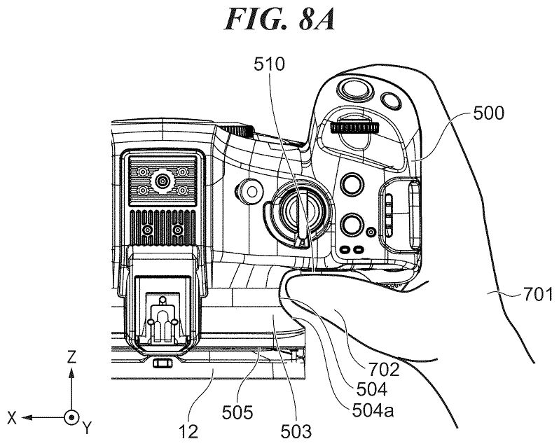

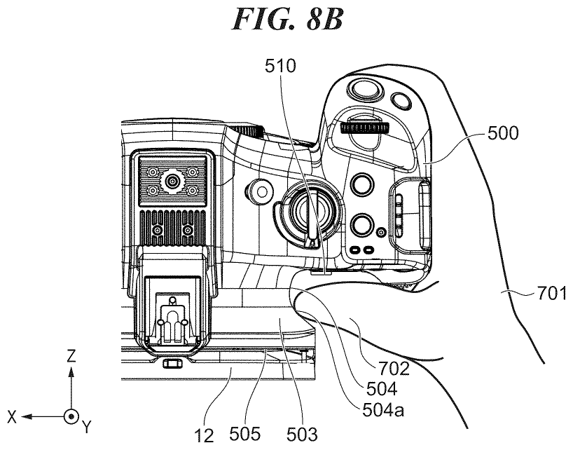

FIG. 8A and FIG. 8B are partial top views of the image pickup apparatus 1000 when the eight-direction key 510 is operated.

As shown in FIG. 7, the eight-direction key 510 is disposed at a position that is capable of being operated by the thumb 702 while holding the grip unit 500, and as a result, when viewed from the optical axis O1 direction, a positional relationship, in which the thumb 702 operating the eight-direction key 510 or the like overlaps with a part of the display unit 12, is established. If the positional relationship between the eight-direction key 510 and the display unit 12 is shifted in the X direction so that the thumb 702 does not overlap with the display unit 12 when viewed from the optical axis O1 direction, the outer shape of the image pickup apparatus 1000 will become larger in the X direction. In order to avoid an increase in size, in the case where the thumb 702 and the display unit 12 are configured to overlap when viewed from the optical axis O1 direction, it is necessary to take care when forming the protrusion portion 503 so as not to reduce the operability.

Therefore, as shown in FIG. 8A and FIG. 8B, a recess portion 504 is provided on the left side portion of the protrusion portion 503. The recess portion 504 is formed in a shape recessed in the +X direction. The recess portion 504 is formed so that the thumb 702 of the right hand 701 holding the grip unit 500 is capable of being accommodated therein (so that the thumb 702 of the right hand 701 holding the grip unit 500 is capable of being placed thereinto).

Since the photographer is able to place the thumb 702 that operates the eight-direction key 510 into the recess portion 504, it is possible to prevent a decrease in the operability due to the thumb 702 coming into contact with the protrusion portion 503. In other words, the protrusion portion 503 does not interfere with the operation. In addition, as shown in FIG. 8B, in the case where the photographer is not operating the eight-direction key 510, the photographer is able to press the thumb 702 against an abutment portion 504a of the recess portion 504 on the side away from the eight-direction key 510. As a result, it is possible to suppress an erroneous operation of the eight-direction key 510, and it is also possible to allow the grip unit 500 to be held more stably.

When viewed from the optical axis O1 direction, a part of the closed display unit 12 and a part of the recess portion 504 overlap with each other. Here, if a space into which the thumb 702 is capable of being placed (in which the thumb 702 is capable of being accommodated) is provided by cutting out a part of the protrusion portion 503, there will be a risk that the thumb 702 carelessly hits the display unit 12 facing the top surface 505. Therefore, in the case where the display unit 12 is configured to be capable of being opened and closed relative to the image pickup apparatus main body 1000a, this may also lead to an erroneous operation.

However, the recess portion 504 is configured to be provided in the area connecting the arrangement surface 500a and the top surface 505, be recessed in the +X direction, and have a wall between the display unit 12 and the thumb 702. Therefore, when viewed from the optical axis O1 direction, a part of the top surface 505 and a part of the recess portion 504 overlap with each other. With this configuration, there is no risk of the thumb 702, which has been placed into the recess portion 504, carelessly hitting the display unit 12. In this way, it is possible to suppress erroneous operations of other parts (other operation members) while maintaining good operability of the eight-direction key 510.

It should be noted that although such measures to suppress an erroneous operation have been described primarily with respect to the eight-direction key 510, the same may be applied to other operation members as long as they are disposed within a range that is capable of being operated by the thumb 702. For example, the same may be applied to a push button type operation member or a rotary dial type operation member. In addition, the recess portion 504 may be formed over the entire area of the image pickup apparatus main body 1000a in the Y direction, or may be formed in a partial range.

According to the first embodiment, the fixing hole 11 (the first fixing portion) is located on the subject side in the optical axis direction with respect to the accessory shoe 10 (the second fixing portion), and is located above the accessory shoe 10. The accessory shoe 10 is located on the subject side in the optical axis direction with respect to the display unit 12, and is located above the uppermost position H1 (see FIG. 4) of the display unit 12.

With this configuration, since the accessory attaching space 21 is created, even in the case where the handle has been fixed to the fixing hole 11, it is possible to fix the accessory to the accessory shoe 10. Therefore, it is possible to enable the use of the handle and the function extension accessory together, and it is possible to improve the operability and the functionality of the image pickup apparatus in a photographing scene. As a result, it is possible to enable the use of the handle and the accessory together and be capable of ensuring the good attachment of the accessory.

In addition, since the recess portion 504 has been formed on the side portion of the protrusion portion 503, when the operation member is operated by the thumb 702, the protrusion portion 503 does not interfere with the operation. Furthermore, since a part of the display unit 12 and a part of the recess portion 504 overlap with each other when viewed from the optical axis direction, it is possible to reduce the risk of the thumb 702 carelessly hitting the display unit 12.

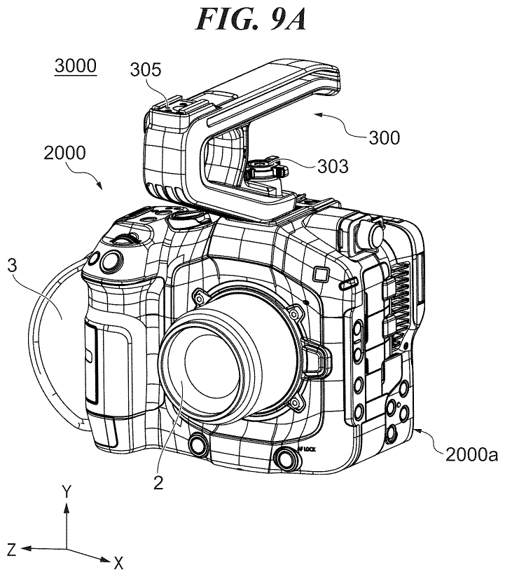

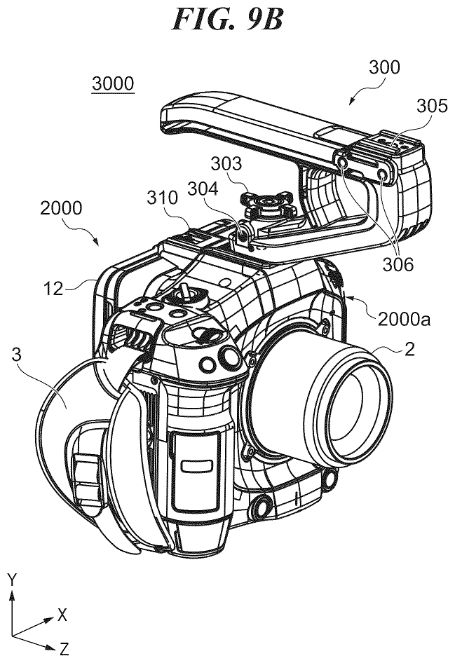

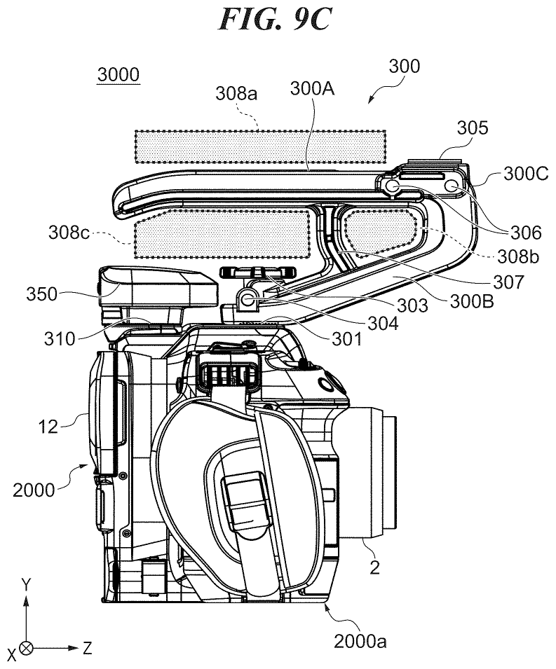

Next, a second embodiment of the present invention will be described. FIG. 9A and FIG. 9B are front perspective views of an image pickup apparatus system 3000 including an image pickup apparatus 2000 according to the second embodiment. FIG. 9C is a side view of the image pickup apparatus 2000 as viewed from the −X side. It should be noted that the XYZ coordinate system is the same as in the first embodiment.

The image pickup apparatus system 3000 according to the second embodiment includes the image pickup apparatus 2000, a lens 2, a grip belt 3, and a handle 300. The image pickup apparatus 2000 includes an image pickup apparatus main body 2000a and a display unit 12. It should be noted that descriptions of the same components as those of the image pickup apparatus 1000 in the first embodiment will be omitted. The configurations of the lens 2, the grip belt 3, and the display unit 12 are the same as those in the first embodiment.

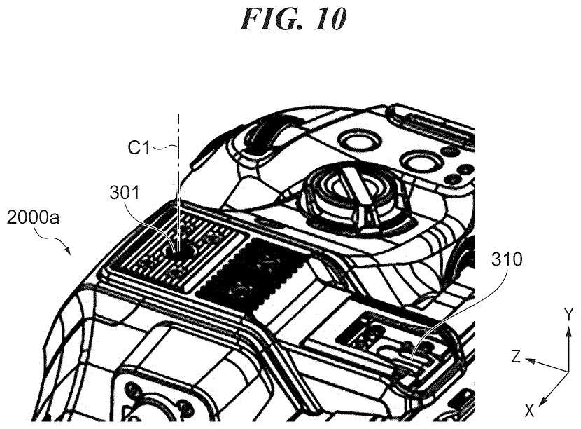

The configurations of a fixing hole 301 (see FIG. 10) and an accessory shoe 310 (see FIG. 10) are similar to the configurations of the fixing hole 11 and the accessory shoe 10 in the first embodiment. FIGS. 9A to 9C show a state in which the handle 300 has been attached to the fixing hole 301. FIG. 9C shows a state in which a function extension accessory 350 has been attached to the accessory shoe 310. The function extension accessory 350 is, for example, a wireless microphone receiving device or an external global positioning system (an external GPS), but is not limited to these. As shown in FIG. 9A, the handle 300 has been fixed to the fixing hole 301 (see FIG. 10) by a fixing screw 303.

As shown in FIG. 9B, the handle 300 is provided with an accessory shoe 305, which is a cold shoe for attaching an accessory such as a microphone. In addition, the handle 300 is provided with fixing holes 306 for attaching a microphone holder, and a fixing hole 304 for attaching an accessory such as a cable clamp or a measure hook. The fixing hole 304 will be described in detail below.

As shown in FIG. 9C, the handle 300 is configured in a C-shape, and opens toward the −Z side in a state in which the handle 300 has been attached to the image pickup apparatus main body 2000a. In other words, the handle 300 includes a first portion 300A including an area that is primarily held (gripped), a second portion 300B including an area that is fixed to the fixing hole 301, and a strut portion 307. The second portion 300B is a portion that is folded back at an end portion 300C in a longitudinal direction of the first portion 300A. The strut portion 307 is a portion that connects the first portion 300A and the second portion 300B substantially in the Y direction.

An area above the first portion 300A is a first holding range 308a. A second holding range 308b is formed between the first portion 300A and the second portion 300B and between the strut portion 307 and the end portion 300C. An area opposite the end portion 300C with respect to the strut portion 307 is a third holding range 308c.

The photographer holds (grips) the handle 300 by pressing the palm of his/her hand against the first holding range 308a from the +Y direction and gripping the handle 300 with any fingers passing through the second holding range 308b and the third holding range 308c. The second holding range 308b and the third holding range 308c that are formed on both sides of the strut portion 307 serve as spaces into which the fingers of the hand holding (gripping) the first portion 300A is capable of fitting.

When holding (gripping) the handle 300, the photographer is able to stably carry the image pickup apparatus 2000 by pinching the strut portion 307 with the finger that has passed through the second holding range 308b and the finger that has passed through the third holding range 308c.

In addition, since the handle 300 has an opening toward the rear surface side (has a shape that opens toward the rear surface side), when the function extension accessory 350 is attached to the accessory shoe 310 of the image pickup apparatus 2000 from the −Z side, it is possible to avoid interference between the function extension accessory 350 and the handle 300.

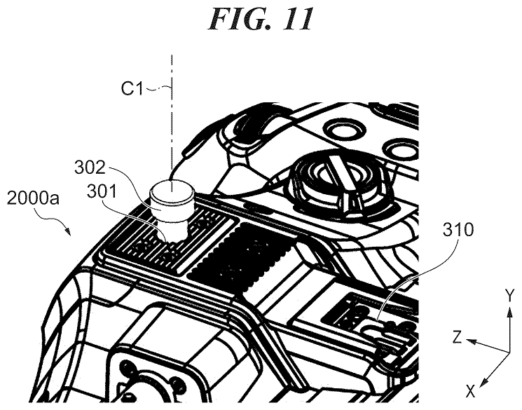

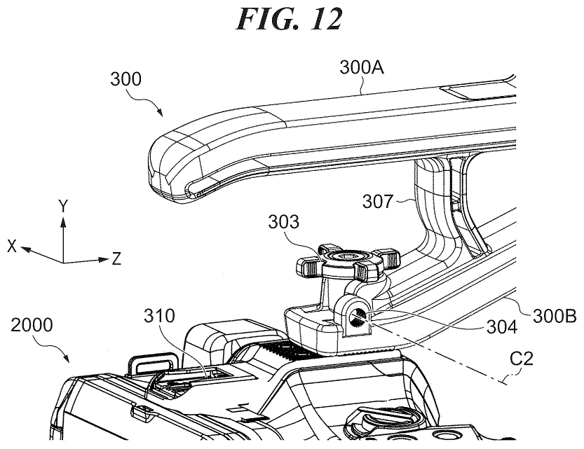

FIG. 10 and FIG. 11 are partial rear perspective views of the image pickup apparatus main body 2000a. FIG. 11 shows a state in which a measure hook 302 has been attached to the fixing hole 301. FIG. 12 is a partial front perspective view of the image pickup apparatus 200 with the handle 300 attached.

The relative positional relationship between the fixing hole 301, the accessory shoe 310, and the display unit 12 is similar to the relative positional relationship between the fixing hole 11, the accessory shoe 10, and the display unit 12 in the first embodiment.

Generally, a measure hook is a hook onto which a photographer is able to hook a measure in order to measure a focal distance from the center (a principal point) of a lens to a sensor surface of an image pickup device (an image sensor). In the second embodiment, the measure hook 302 is capable of being screwed into the fixing hole 301, and is used to measure a focal distance from the light receiving surface 910a (see FIG. 2) of the image pickup device 910 while being screwed into the fixing hole 301.

The position of a central axis line C1 (see FIG. 10) of the fixing hole 301 as a screw hole substantially coincides with the light receiving surface 910a in the Z direction. In other words, the central axis line C1 is located on the same plane as the light receiving surface 910a and is parallel to the light receiving surface 910a. Therefore, when a measure has been hooked onto the measure hook 302 that has been attached to the fixing hole 301, a measuring end of the measure coincides with the light receiving surface 910a, and an axis line of the measure hook 302 is on the light receiving surface 910a and becomes parallel to the light receiving surface 910a. When the handle 300 is not in use, it is possible to fix the measure hook 302 into the fixing hole 301 (see FIG. 11).

As shown in FIG. 12, the handle 300 is provided with the fixing hole 304 for attaching an accessory or the like. The fixing hole 304 is a screw hole similar to the fixing hole 301 of the image pickup apparatus main body 2000a, and the same screw is capable of being screwed into the fixing hole 304 and the fixing hole 301. Therefore, it is also possible to fix the measure hook 302 into the fixing hole 304.

In a state in which the handle 300 has been fixed to the image pickup apparatus main body 2000a, the position of a central axis line C2 of the fixing hole 304 as a screw hole substantially coincides with the light receiving surface 910a in the Z direction. In other words, the central axis line C2 is located on the same plane as the light receiving surface 910a and is parallel to the light receiving surface 910a. Therefore, even in the state in which the handle 300 has been fixed to the image pickup apparatus main body 2000a, by attaching the measure hook 302 to the fixing hole 304 and hooking the end of the measure onto the measure hook 302, it is possible to use the measure hook 302 to measure the focal distance from the light receiving surface 910a.

Although not shown, it is also possible to attach, to the fixing hole 304, an accessory other than the measure hook 302, such as a cable clamp that is capable of securing a cable of an external accessory. In the case where a cable clamp has been attached to the fixing hole 304, by the cable clamp being shaped so that a measure is capable of being hooked onto the cable clamp, it is also possible to use the cable clamp as a measure hook. In this way, by making it possible to use the fixing hole 304 in combination, it is possible to reduce the number of parts and enhance the functionality.

It should be noted that in a state in which the handle 300 has been fixed to the fixing hole 301, when viewed from above, a part of the handle 300 overlaps with the fixing hole 301 and the accessory shoe 310. This configuration is also the same in the first embodiment.

According to the second embodiment, it is possible to achieve the same effect as the first embodiment in that it is possible to enable the use of the handle and the accessory together and be capable of ensuring the good attachment of the accessory.

In addition, since the measure hook 302 is capable of being attached to the fixing hole 301 and being used to measure the focal distance, there is no need to provide a separate attachment portion for the measure hook 302, which contributes to the miniaturization of the image pickup apparatus.

In addition, even in the state in which the handle 300 has been fixed to the image pickup apparatus main body 2000a, the measure hook 302 is capable of being attached to the fixing hole 304 of the handle 300 and being used to measure the focal distance.

It should be noted that the configuration of the display unit 12 is not limited to a movable type such as an openable type. In the case where the display unit 12 is a non-movable type, when designing the relative positional relationship between the fixing hole 11, the accessory shoe 10, and the display unit 12, or the relative positional relationship between the fixing hole 301, the accessory shoe 310, and the display unit 12, the display surface 12a is set (designed) to be perpendicular to the optical axis.

Although the present invention has been described above in detail based on its preferred embodiments, the present invention is not limited to these specific embodiments, and the present invention also includes various forms without departing from the gist of the present invention. Some (part) of the above-described embodiments may be combined as appropriate.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-076531, filed on May 9, 2024, which is hereby incorporated by reference herein in its entirety.

What is claimed is:

1. An image pickup apparatus comprising:
a first fixing portion to which at least a handle is capable of being fixed;
a second fixing portion to which an accessory is capable of being fixed; and
a display unit that includes a display surface perpendicular to an optical axis direction, and
wherein the first fixing portion is located on a subject side in the optical axis direction with respect to the second fixing portion and is located above the second fixing portion, and
the second fixing portion is located on the subject side in the optical axis direction with respect to the display unit, and is located above an uppermost position of the display unit.

2. The image pickup apparatus according to claim 1, further comprising:
a holding portion that is disposed on a side portion of an image pickup apparatus main body for holding the image pickup apparatus main body;
an operation member that is disposed on an arrangement surface facing a photographer side in the optical axis direction of the holding portion, at a position operable by a thumb of a hand holding the holding portion; and
a protrusion portion that is provided on the image pickup apparatus main body and protrudes toward the photographer side than the arrangement surface in the optical axis direction, and
wherein a recess portion, in which the thumb of the hand holding the holding portion is capable of being accommodated, has been formed on a side portion of the protrusion portion.

3. The image pickup apparatus according to claim 2, wherein
when viewed from the optical axis direction, a part of a surface on the photographer side of the protrusion portion and a part of the recess portion overlap with each other.

4. The image pickup apparatus according to claim 3, wherein
the display unit is disposed so as to face the surface on the photographer side of the protrusion portion, and
when viewed from the optical axis direction, a part of the display unit and a part of the recess portion overlap with each other.

5. The image pickup apparatus according to claim 4, wherein
the display unit is connected to the image pickup apparatus main body in an openable and closable manner, and
the display unit faces the surface in a closed state, and overlaps with a part of the recess portion when viewed from the optical axis direction.

6. The image pickup apparatus according to claim 2, wherein
a cooling structure is disposed inside of the protrusion portion.

7. The image pickup apparatus according to claim 1, wherein
the display unit is movable, and
when the display unit is at any of its positions, the display unit does not overlap with the second fixing portion when viewed from the optical axis direction.

8. An image pickup apparatus system comprising:
the image pickup apparatus according to claim 1; and
a handle that is capable of being fixed to the first fixing portion of the image pickup apparatus, and
wherein the handle comprises
a first portion that includes an area that is primarily held;
a second portion that is a portion that is folded back at an end portion in a longitudinal direction of the first portion, the second portion including an area that is fixed to the first fixing portion; and
a strut portion that connects the first portion and the second portion, and
spaces, into which fingers of a hand holding the first portion is capable of fitting, are formed on both sides of the strut portion.

9. The image pickup apparatus system according to claim 8, wherein
in a state in which the handle has been fixed to the first fixing portion, when viewed from above, a part of the handle overlaps with the first fixing portion and the second fixing portion.

10. The image pickup apparatus system according to claim 8, wherein
the first fixing portion includes a screw hole,
an axis line of the screw hole is located on a same plane as a light receiving surface of an image pickup device of the image pickup apparatus and is parallel to the light receiving surface,
the handle includes a third fixing portion including a screw hole to which an accessory is capable of being fixed, and
in a state in which the handle has been fixed to the first fixing portion, an axis line of the screw hole of the third fixing portion is located on a same plane as the light receiving surface and is parallel to the light receiving surface.

11. The image pickup apparatus system according to claim 10, wherein
a same screw is capable of being screwed into the screw hole of the first fixing portion and the screw hole of the third fixing portion.

12. The image pickup apparatus system according to claim 10, wherein
a cable clamp is capable of being fixed to the third fixing portion.
